(19) United States
(12) Patent Application Publication
(10) Pub. No.: US 2020/0398451 A1
(43) Pub. Date: Dec. 24, 2020

(54) KISS-CUT DRAW KNIFE

(71) Applicant: ZÜND SYSTEMTECHNIK AG, Altstätten (CH)

(72) Inventors: Claude ZIMMERMANN, Arbon (CH); Simon JANN, Altstätten (CH)

(21) Appl. No.: 16/911,245

(22) Filed: Jun. 24, 2020

(30) Foreign Application Priority Data
Jun. 24, 2019 (EP) 19182081.0

(51) Int. Cl. B26D 1/00; B26D 7/26; B26F 1/38; B26D 3/08

(52) U.S. Cl. CPC B26D 1/0006; B26D 7/2614; B26F 1/3813; B26D 7/018; B26D 2001/0053; B26D 2001/006; B26D 3/085

(57) ABSTRACT

Disclosed is a cutting machine knife designed for kiss-cut cutting of a sticker. A sticker backing includes a backing layer and an adhesion-reducing layer. The sticker includes a cover layer and an adhesive layer releasably adhered to the adhesion-reducing layer. The cutting machine knife includes a holding section for inserting the cutting machine knife into a knife holder of the cutting tool, a longitudinal axis disposed at a right angle to a cutting direction, a blade having a cutting edge and a back. The cutting edge, when viewed in a plane defined by the cutting direction and the longitudinal axis, forms with the cutting direction a first angle which is less than 90° and an intermediate zone between the cutting edge and the back which, again when viewed in said plane, encloses with the cutting direction a second angle which is between 130° and 170°.

### FIELD OF THE INVENTION

The present invention relates to a cutting machine knife which is designed and precisely intended for kiss-cut cutting or through-cut cutting of stickers.

### BACKGROUND OF THE INVENTION

For such a cutting of stickers, cutting machines are used which provide a kiss-cut cutting mode and a through-cut cutting mode and in whose cutting tool the cutting machine knife according to the invention is inserted.

Kiss-cut cutting involves cutting through a top side, i.e. the sticker itself, so that it can be removed in the desired shape. In doing so, an underside, i.e. the backing layer to which the sticker adheres, remains undamaged or is only slightly scored, scratched or incised. To facilitate removal, the backing layer is usually provided with an adhesion-reducing coating, wherein the sticker, which has a special adhesive layer, adheres detachably to this adhesion-reducing coating.

During through-cut cutting, both sides—the sticker and the backing layer—should be cut through, as it is desired that the sticker as a whole (i.e. with the backing layer) already shows its shape. To make it easier to remove the sticker, an additional flap can also be cut out, wherein here a small kiss-cut is usually made at the transition between flap and sticker so that the flap is not part of the sticker.

For a perfect cutting result there are special requirements for the knives used in the cutting modes mentioned above. Cutting machine knives are known from the prior art which have a pointed blade tip or a blade tip formed parallel to the cutting direction. Such knives are not optimal for the cutting process and have a limited service life, as their blade tips tend to wear out early.

### OBJECT OF THE INVENTION

It is therefore an object of the invention to create an improved to provide generic cutting machine knives for kiss-cut cutting and through-cut cutting. Due to its design, the cutting machine knife according to the invention is significantly less susceptible to wear, thus enabling a more stable cutting process and offering a longer service life with constant cutting precision.

### SUMMARY OF THE INVENTION

The invention relates to a cutting machine knife for use in a cutting tool of a cutting machine, designed and precisely provided for cutting a sticker in a kiss-cut cutting mode of the cutting machine, in particular in addition to cutting the sticker in a through-cut cutting mode of the cutting machine, wherein the sticker has a cover layer and an adhesive layer, wherein the sticker backing has an adhesion-reducing layer and a backing layer, wherein the adhesive layer adheres releasably to the adhesion-reducing layer, wherein, within the scope of the kiss-cut cutting mode, the cutting machine knife is automatically guided by the cutting machine along the sticker in a cutting direction and in this process does not or only partially cut through the sticker and the sticker backing, optionally wherein, within the scope of the through-cut cutting mode, the cutting machine knife is automatically guided by the cutting machine along the sticker in a cutting direction and in this process completely cuts through the sticker and the sticker backing, wherein the cutting machine knife comprises the following: a holding section for inserting the cutting machine knife into a knife holder of the cutting tool, a longitudinal axis which is rectangular to the cutting direction, a blade having a cutting edge and a back, wherein the cutting edge, when viewed in a plane defined by the cutting direction and the longitudinal axis, forms with the cutting direction a first angle which is less than 90°, and an intermediate zone between the cutting edge and the back, which, again when viewed in said plane, forms with the cutting direction a second angle which is between 130° and 170°.

The second angle is between 140° and 160°, in particular 150° in one embodiment.

The first angle is less than 70° in a further embodiment, in particular between 20° and 65°, in particular 35°, 45° or 60°.

The blade between the cutting edge and the intermediate zone shows preferably a point which is formed in a pointed or rounded manner, in particular wherein the cutting edge and the intermediate zone include a third angle resulting from subtracting the second angle from the first angle.

The blade may taper along the longitudinal axis and in relation to an axis perpendicular to the longitudinal axis and to the direction of cutting, at least on one side, in particular on both sides, towards the tip, and taper in particular in a linear or curved concave or convex manner.

A normal distance of the tip to the longitudinal axis is less than 0.04 mm in one embodiment, in particular 0.02 mm, and especially 0.01 mm.

The back may taper parallel to the direction of cutting and in relation to an axis perpendicular to the longitudinal axis and to the cutting direction, at least on one side, in particular on both sides, and taper in particular in a linear or curved concave or convex manner.

The intermediate zone forms in particular a wedge-shaped triangular area, which extends from the tip to the back.

The longitudinal axis is preferably an axis of symmetry of at least part of the cutting machine knife, in particular a central shaft, and wherein the axis of symmetry extends through the back with a tolerance of −0.01 mm to +0.01 mm, in particular wherein the back extends parallel to the longitudinal axis.

The intermediate zone may have a length, in particular between the tip and the back, of less than 0.04 mm, in particular between 0.03 mm and 0.01 mm, especially 0.02 mm.

At least one of: the cutting edge, the intermediate zone and the back, again when viewed in said plane, especially extends in a linear or curved concave or convex manner.

The cutting machine knife preferably has a length of between 10 mm and 30 mm, in particular a length of less than 20 mm.

The cutting edge has a depth along the longitudinal axis of between 0.5 mm and 3 mm, in particular a depth of between 1 mm and 2.6 mm.

The holding section has a diameter of between 2 mm and 4 mm in one embodiment, in particular a diameter of 3 mm.

The invention further relates to a use of the cutting machine knife according to the description herein used in a cutting machine with cutting tool.

The invention also relates to a cutting machine having a cutting tool into which the cutting machine knife is inserted according to the description herein, wherein the cutting machine provides a kiss-cut cutting mode or a through-cut cutting mode intended for cutting a sticker, wherein the sticker has a cover layer and an adhesive layer, wherein the sticker backing has an adhesion-reducing layer and a backing layer, wherein the adhesive layer is releasably adhered to the adhesion-reducing layer, wherein, within the scope of the kiss-cut cutting mode, the cutting machine knife is automatically guided by the cutting machine in a cutting direction along the sticker and in this process cuts through the sticker completely and does not or only partially cut through the sticker backing, wherein, within the scope of the through-cut cutting mode, the cutting machine knife is automatically guided by the cutting machine in a cutting direction along the sticker and in this process completely cuts through the sticker and the sticker backing.

### BRIEF DESCRIPTION OF THE DRAWINGS

Further advantages of the present invention can be seen from the detailed description and drawings.

FIG. 1 shows a generic cutting machine for which the cutting machine knife according to the invention is precisely designed and constructed;

FIG. 2 shows an embodiment of the cutting machine knife according to the invention;

FIG. 3 shows the tip of the blade of the cutting machine knife from FIG. 2 in a detailed view, showing the sticker to be cut, the sticker backing and the cutting direction;

FIG. 4 shows the tip of the blade of the cutting machine knife from FIG. 2 in a three-dimensional detail view;

FIG. 5 shows a detailed view of the layer structure of the sticker to be cut from FIG. 3;

FIGS. 6 and 7 show a prior art cutting machine knife of the generic type;

### DETAILED DESCRIPTION OF THE DRAWINGS

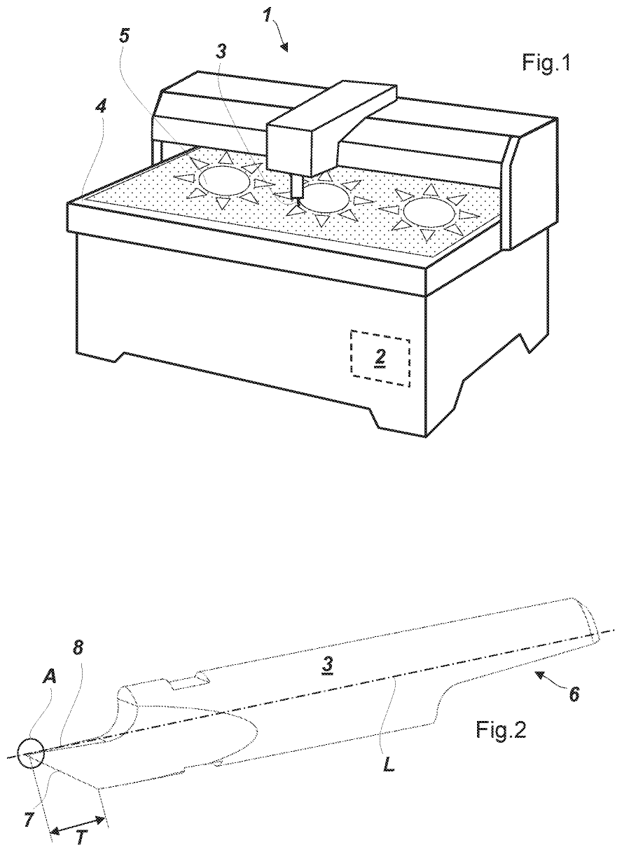

FIG. 1 shows a generic cutting machine 1, which can move a cutting tool in X and Y direction over a machine table 4 by means of a portal. This is usually controlled by a control unit 2, which can be located in the cutting machine or externally. The cutting machine knife 3 is designed to be inserted into the tool holder. With specially adjustable forces (e.g. via a spring force or a servomotor) the cutting machine knife 3 is pressed in a defined manner onto the object to be cut 5. This pressure is used for so-called kiss-cut cutting, in which only an upper layer of the object 5 is completely severed and a backing layer carrying this upper layer either remains undamaged or is at best minimally scored or scratched by the knife 3.

If the defined pressing force is increased in a defined manner, or if a defined cutting depth is set, the cutting machine knife according to the invention can also be used to advantage for through-cut cutting, in which the object 5 is completely cut through and the knife tip only slightly touches the machine table 4. The machine table 4 is usually permeable to air, because the object 5 can be held on the table 4 by an air suction by the force of a vacuum created by this. The surface material of the table 4 can be based on polyurethane or a non-woven fabric.

Object 5 is preferably a sticker that adheres to its backing material, or more generally speaking: a material that carries one or more stickers. Usually such stickers are self-adhesive foils or paper.

A pressure mode is used for cutting stickers (pressing already mentioned above). Which foil type is cut with which pressure depends on the material specifications and must be determined and thus defined by means of cutting tests if necessary. The cutting machine is designed to measure the pressure exerted by the tip on the material. When the defined pressure is reached, this can optionally be indicated by a green LED.

The optimum processing depth is achieved in kiss cutting when the knife cuts through the cover layer 100, the adhesive layer 101 and part of the sticker backing 11. This means that the adhesion-reducing layer 111 is scored, cut or severed, and the backing layer 110 is cut or remains intact. The components are marked in FIG. 5. This type of cut ensures that a sticker can be removed from the sticker backing without tearing the sticker backing. Commonly used foil materials reach thicknesses of up to 3 mm.

In through-cutting, the optimum machining depth is achieved when the knife cuts through all layers, i.e. the sticker 10 and the sticker backing 11, without damaging the machine table 4.

The knife can be surrounded by a (e.g. cylindrical) slider on the cutting tool, which presses the object 5 to be cut against the table 4 at the cutting area. This again (i.e. in addition to a possible vacuum suction function of the table 4, which fixes the object 5 securely) ensures that the cut is performed cleanly. The use of the slider is particularly suitable for processing reflective foils.

A pressure mode can be designed in such a way that the module (cutting tool) exerts a constant pressure, adjustable between 30 and 3500 grams, on the machining material 5.

In addition to the pressure mode, there is also a so-called position mode, which is not suitable for kiss cutting, but only for cutting through (through cutting), in which a cutting depth is set (and therefore no pressure), which ensures that the material is cut through completely and the table is not cut. The position mode is therefore an alternative to the pressure mode for through-cutting.

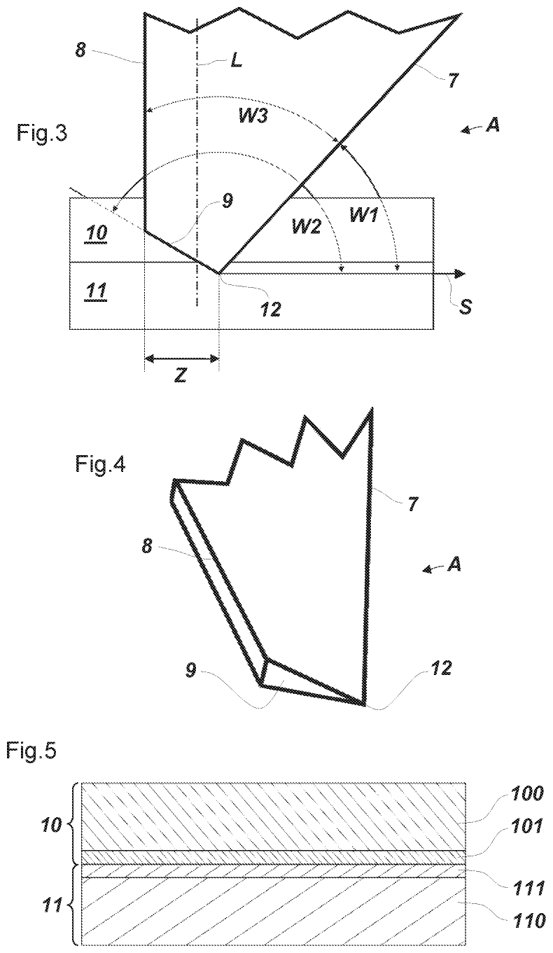

The cutting machine knife 3 according to the invention is designed precisely for the kiss-cut cutting mode and the through-cut cutting mode and ensures that precise and predictive cutting results are achieved by setting defined cutting pressures or defined cutting depths. An embodiment of the invention is shown in FIGS. 2 and 3. The semi-cylindrical holding section 6 is used for clamping in the cutting tool of cutting machine 1 and ensures that the knife is precisely aligned. The holding section shown is not essential to the invention and the person skilled in the art is aware of further possibilities of shaping a holding section.

Cutting machine knives are usually made of a cylindrical raw material. In the middle section of knife 3, this cylinder is essentially still intact and in relation to this, a longitudinal axis L is defined for the cutting machine knife 3, which is a symmetry axis for this same middle section.

With the cutting edge 7, the cutting machine knife 3 naturally comes into contact with the object to be cut first, as the cutting direction S in FIG. 3 indicates. The cutting direction S is a vector that starts from the cutting edge and points in the direction of the cutting feed. In the example in FIG. 1, the tool moves relative to the table, but there are also possible embodiments where the table moves relative to the tool. Usually, the cutting direction S is perpendicular to the longitudinal axis L. A depth T of cutting edge 7—viewed parallel to the longitudinal axis L—is preferably between 0.5 mm and 3 mm.

The blade of knife 3 also has a back 8, which is located away from the first slice. According to the invention, there is an angled intermediate zone 9 between the cutting edge 7 and the back 8, which ensures a surprisingly high wear resistance of the knife in the mentioned cutting modes and thus a long lasting and constant precision of the cutting results. In addition, the cutting machine knife, which is in accordance with the invention, allows a lower piercing force in both cutting modes as well as a lower cutting force (along the cutting direction) compared to known knives.

The view of FIG. 3 is in a plane that is spanned by the longitudinal axis L and the cutting direction S. According to the invention, the intermediate zone 9 in this view has an angle W2 to the longitudinal axis L of between 40° and 80°. This means that an angle with the cutting direction S of 130° to 170° prevails. If this angle approaches the range of about 60° (with respect to L) or 150° (with respect to S), an optimum of the effects according to the invention is increasingly achieved. The longitudinal axis L in FIG. 3 extends through the intermediate zone 9, but preferably extends along the back 8, with a tolerance range around the back of −0.01 mm to +0.01 mm.

If reference is made to the cutting edge, the back and the intermediate zone, their edges are generally referred to. These edges are preferably straight in each case, i.e. linear. However, in other embodiments they can also have a curve-like course.

Within the scope of kiss-cutting, the tip 12 of the blade protrudes “just so” into the sticker backing 11, so that the sticker backing 11 is not damaged, but the sticker 10 is completely cut through. In this situation, load peaks occur, which require special demands on the design of the cutting machine knife. Similar load peaks occur during through-cutting, where the knife tip touches the machine table.

The intermediate zone 9 has—considered normal to the longitudinal axis L or parallel to the cutting direction S—between the tip 12 and the back 8 a length Z, which is preferably less than 0.04 mm, in particular between 0.03 mm and 0.01 mm, in particular 0.02 mm.

FIG. 4 shows area A again in a three-dimensional (but not necessarily true to scale) view. It is illustrated here how the intermediate zone 9 forms a wedge-shaped triangular surface, which extends from tip 12 to back 8, i.e. a triangle is formed by the two corners at back 8 and tip 12. This surface can be completely flat, or in other embodiments concave or convex. The back also preferably comprises a flat surface, as can be seen in FIG. 4. This surface can also take on other shapes in other embodiments—as with the above-mentioned triangular surface of the intermediate zone. The cutting edge 7 is of course sharpened and is therefore a sharp edge. The sharpening can also be linear or curved (concave or convex).

FIG. 5 shows once again in detail the layers of the object to be cut in the side view. The sticker 10 has a cover layer 100 and an adhesive layer 101 which is firmly attached to the cover layer 100. With this adhesive layer 101, the sticker 10 adheres to the adhesion-reducing layer 111 of the sticker backing 11. The adhesion-reducing layer 111 in turn is firmly connected to the backing layer 110. The material of the adhesion-reducing layer 111 is based on silicone or a wax, for example. The cover layer 100 and the backing layer 110 can consist of paper and/or plastic film.

By its design, the knife 3 according to the invention specifically improves the process of cutting stickers and minimizes the wear and tear that occurs on prior-art knives, which is briefly explained below.

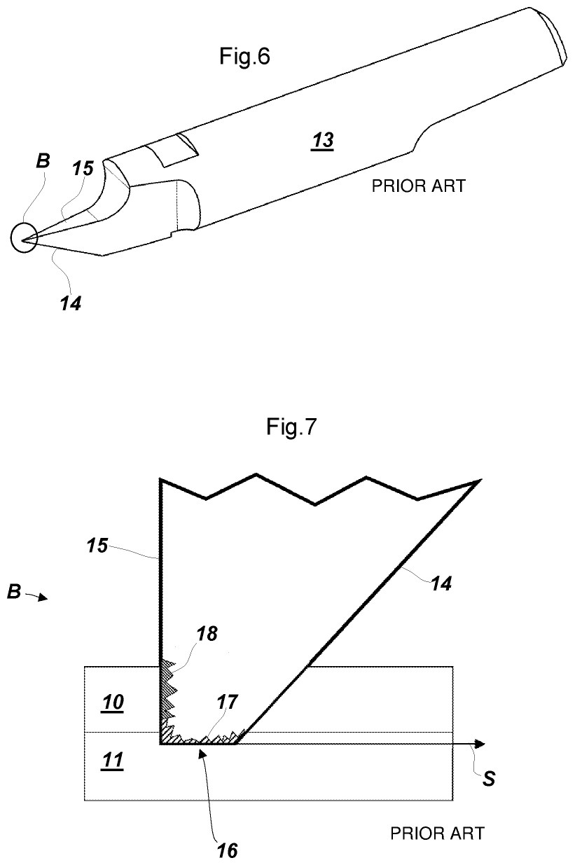

FIG. 6 shows the construction of a kiss-cut knife with cutting edge 14 and back 15. FIG. 7 shows in detail the tip area marked B in FIG. 6. Between cutting edge 14 and back 15 there is a so-called flat point 16, which also protrudes slightly into the backing 11 during kiss-cut cutting and cuts through the sticker 10 completely. The flat point 16 is intended to prevent a “perfect”, i.e. completely pointed tip from breaking off.

The cutting process of such a knife 13 known from the prior art is, however, not optimal, because depending on the design of the flat point 16, the area of the knife back 15 rests on the backing layer. This causes higher cutting forces and vibrations during cutting, which impairs the cutting result. Furthermore, the service life is severely limited by this effect. This is due to wear, which is shown by first breaks 17 in the area of the flat point 16 and second breaks 18 in the area of the back 15. The results of kiss-cut cutting and through-cut cutting therefore no longer meet the requirements at a relatively early stage and the blade has to be replaced. In addition, flat point 16 causes higher piercing forces, which is relevant because the cutting machine knife is usually lifted off frequently in a sticker-cutting process and pierced again (at a different position or in a different orientation).

The knife 3 according to the invention avoids all these wear and tear phenomena and thus offers a significantly better cutting quality as well as an increased service life.

Although the invention has been explained in terms of its preferred embodiment(s), many other changes and variations can be made without going beyond the scope of the present invention. It is therefore provided that the enclosed claims cover amendments and variations which are contained in the actual scope of the invention.

1. A cutting machine knife for insertion into a cutting tool of a cutting machine, designed and precisely provided for cutting a sticker in a kiss-cut cutting mode of the cutting machine, in particular in addition to cutting the sticker in a through-cut cutting mode of the cutting machine,
wherein the sticker comprises a cover layer and an adhesive layer,
wherein the sticker backing comprises an adhesion-reducing layer and a backing layer,
wherein the adhesive layer adheres detachably to the adhesion-reducing layer,
wherein within the scope of the kiss-cut cutting mode the cutting machine knife is automatically guided by the cutting machine in a cutting direction (S) along the sticker and in this process cuts through the sticker entirely and the sticker backing not at all or only partially,
optionally wherein, in the through-cut cutting mode, the cutting machine knife is automatically guided by the cutting machine in a cutting direction (S) along the sticker and in so doing completely cuts through the sticker and the sticker backing entirely,
wherein the cutting machine knife comprises:
a holding section for inserting the cutting machine knife into a knife holder of the cutting tool,
a longitudinal axis (L) disposed at a right angle to the cutting direction,
a blade having a cutting edge and a back, wherein the cutting edge, when viewed in a plane defined by the cutting direction and the longitudinal axis, forms with the cutting direction a first angle (W1) which is less than 90°,
wherein an intermediate zone located between the cutting edge and the back, which, again when viewed in said plane, forms with the cutting direction a second angle (W2) of between 130° and 170°.

2. The cutting machine knife according to claim 1, wherein the second angle (W2) is between 140° and 160°, in particular 150°.

3. The cutting machine knife according to claim 1, wherein the first angle (W1) is less than 70°, in particular between 20° and 65°, especially 35°, 45° or 60°.

4. The cutting machine knife according to claim 1, wherein the blade comprises, between the cutting edge and the intermediate zone, a tip which is pointed or rounded, in particular wherein the cutting edge and the intermediate zone enclose a third angle (W3) resulting from a subtraction of the second angle (W2) from the first angle (W1).

5. The cutting machine knife according to claim 4, wherein the blade tapers along the longitudinal axis (L) and relative to an axis perpendicular to the longitudinal axis and to the cutting direction, towards the tip at least on one side, in particular on both sides, in particular in a linear or curved concave or convex manner.

6. The cutting machine knife according to claim 4, wherein a normal distance of the tip from the longitudinal axis (L) is less than 0.04 mm, in particular 0.02 mm, especially 0.01 mm.

7. The cutting machine knife according to claim 1, wherein the back (8) tapers parallel to the cutting direction (S) and with respect to an axis perpendicular to the longitudinal axis and to the cutting direction, at least on one side, in particular on both sides, in particular in a linear or curved concave or convex manner.

8. The cutting machine knife according to claim 1, wherein the intermediate zone forms a wedge-shaped triangular surface which extends from the tip to the back (8).

9. The cutting machine knife according to claim 1, wherein the longitudinal axis (L) is an axis of symmetry of at least part of the cutting machine knife, in particular of a central shaft, and wherein the axis of symmetry passes through the back with a tolerance of −0.01 mm to +0.01 mm, in particular wherein the back extends parallel to the longitudinal axis.

10. The cutting machine knife according to claim 1, wherein the intermediate zone between the tip and the back has a length (Z) which is less than 0.04 mm, in particular between 0.03 mm and 0.01 mm, especially 0.02 mm.

11. The cutting machine knife according to claim 1, wherein at least one of the cutting edge, the intermediate zone and the back, again when viewed in said plane, extends in a linear or curved concave or convex manner.

12. The cutting machine knife according to claim 1, wherein the cutting machine knife has a length of between 10 mm and 30 mm, in particular a length of less than 20 mm.

13. The cutting machine knife according to claim 1, wherein the cutting edge has a depth (T) along the longitudinal axis (L) of between 0.5 mm and 3 mm, in particular a depth of between 1 mm and 2.6 mm.

14. The cutting machine knife according to claim 1, wherein the holding section has a diameter of between 2 mm and 4 mm, in particular a diameter of 3 mm.

15. The cutting machine knife according to one of claim 1 wherein the cutting machine knife is inserted into a cutting machine with cutting too.
